(19) United States
(12) Patent Application Publication
(10) Pub. No.: US 2025/0005414 A1
(43) Pub. Date: Jan. 2, 2025

(54) ADIABATIC OPTICAL INTERFACES SECURED USING PHOTO-ACTIVATED LITHOGRAPHY

(71) Applicant: Amazon Technologies, Inc., Seattle, WA (US)

(72) Inventors: Bartholomeus Johannes Machielse, Somerville, MA (US); Beibei Zeng, Medford, MA (US); Chawina De-Eknamkul, Cambridge, MA (US); Daniel Riedel, Cambridge, MA (US)

(73) Assignee: Amazon Technologies, Inc., Seattle, WA (US)

(21) Appl. No.: 18/346,084

(22) Filed: Jun. 30, 2023

(51) Int. Cl. G06N 10/40

(52) U.S. Cl. CPC G06N 10/40

(57) ABSTRACT

Systems and methods for securing optical fibers with complimentary tapered ends are described. In some embodiments, optical fibers are aligned to form an adiabatic coupling, and a first one of the optical fibers is secured, via an adhesive, to a structure of an optical device hosting a second one of the optical fibers with which the first optical fibers is coupled. The first and second optical fibers, coupled and secured using the adhesive, are then immersed in a photo-active liquid polymer and two-photon lithography is used to form an additional securing structure around the adiabatically coupled ends of the first and second optical fibers. The additional securing structure is configured to maintain the adiabatic coupling throughout various mechanical and/or thermal shocks the adiabatically coupled fibers may encounter.

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects (e.g., particles) like photons, molecules, atoms, and electrons.

A quantum computing device is a device that utilizes quantum mechanics to allow one to write, store, process and read out information encoded in quantum states, e.g., the states of quantum objects. A quantum object is a physical object that behaves according to the laws of quantum physics. The state of a physical object is a description of the object at a given time.

In quantum mechanics, the state of a two-level quantum system, or simply, a qubit, is a list of two complex numbers, where the sum of squared absolute values of the complex numbers (e.g., |x|²+|y|²) must sum to one. Each of the two complex numbers (e.g., x and y) is called an amplitude, and their respective quasi-probabilities are the squared absolute values of the complex numbers (e.g., |x|² and |y|², respectively). Hence, the square of the absolute value of each complex number corresponds to the probability of event zero or event one happening. A fundamental and counterintuitive difference between a probabilistic bit (e.g., a traditional zero or one bit) and the qubit is that a probabilistic bit represents a lack of information about a two-level classical system, while a qubit contains maximal information about a two-level quantum system.

Quantum computing devices are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be both zero and one at the same time, with different probabilities assigned to zero and one. Entanglement is a strong correlation between quantum particles, such that the quantum particles are inextricably linked in unison even if separated by great distances.

There are different types of qubits that may be used in quantum computers, each having different advantages and disadvantages. For example, some quantum computers may include qubits built from superconductors, trapped ions, semiconductors, photons, etc. Each may experience different levels of interference, errors and decoherence. Also, some may be more useful for generating particular types of quantum circuits or quantum algorithms, while others may be more useful for generating other types of quantum circuits or quantum algorithms.

### BRIEF DESCRIPTION OF THE DRAWINGS

FIG. 1 is a block diagram illustrating a process of securing aligned tapered ends of optical elements that form an adiabatic coupling, wherein the process incudes securing at least one of the optical elements to an optical device structure via an adhesive and using a photo active material and photo-lithography to form an additional securing structure over the aligned tapered ends, according to some embodiments.

FIG. 2 is a flow diagram illustrating steps of a process for securing aligned tapered ends of optical elements using a securing structure formed using a photo active material and photo-lithography, according to some embodiments.

FIG. 3 is a block diagram illustrating photo-activated lithography being performed to form a securing structure over aligned tapered ends of adiabatically coupled optical elements, according to some embodiments.

FIG. 4 is a perspective view of an example securing structure for securing adiabatically coupled optical elements formed using a photo active material and photo-lithography, according to some embodiments.

FIG. 5 illustrates a side-view of an example securing structure having a cylindrical outer shape, according to some embodiments.

FIG. 6 illustrates a side-view of an example securing structure having an inverse hour-glass shape, according to some embodiments.

FIG. 7 illustrates a top view of an optical device comprising a set of optical elements adiabatically coupled to another set of optical elements, wherein securing structures formed via photo-activated lithography are securing the sets of adiabatically coupled optical elements, according to some embodiments.

FIG. 8 illustrates an example implementation of an optical device into which light may be transported via adiabatically coupled optical elements secured using a securing structure formed using photo-activated lithography, according to some embodiments.

FIGS. 9A-9B illustrate an example implementation of an optical device, such as a quantum memory device (e.g., a quantum repeater), into which light may be transported via adiabatically coupled optical elements secured using a securing structure formed using photo-activated lithography, according to some embodiments.

FIG. 10 illustrates an example of a quantum memory device, wherein quantum information storage device(s) of the quantum memory device may be provided photons through adiabatically coupled optical elements secured using a securing structure formed using photo-activated lithography, according to some embodiments.

FIGS. 11A-11B illustrate installation of an optical device, such as a quantum memory device, comprising adiabatically coupled optical elements secured using a securing structure formed using photo-activated lithography, wherein the optical device is being installed into a cryogenic cooling device, according to some embodiments.

FIG. 12 is an example diagram illustrating how entanglement is extended by performing joint measurements of received particles of respective sets of entangled particles distributed via fiber optic network links, such as to/from quantum memory devices, according to some embodiments.

FIG. 13 illustrates an example implementation of an optical device, such as in a satellite communication system, which may include adiabatically coupled optical elements secured using a securing structure formed using photo-activated lithography, according to some embodiments.

FIG. 14 is a block diagram illustrating an example computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, apparatuses, and systems for aligning ends of optical elements and/or securing the aligned ends of the optical elements. For example, a first optical element, such as a fiber optic cable, may need to be aligned with a second optical element, such as a waveguide of a quantum memory. This may be necessary in order to configure an optical device, such as the quantum memory, to receive photons, such as entangled photons indicting quantum information to be stored in the quantum memory. Also, continuing the example, the aligned optical elements (e.g., fiber optic cable and waveguide) may need to be secured in order to maintain the alignment while experiencing various changes in conditions, such as changes in thermal conditions or mechanical shocks. In some embodiments, the processes described herein may provide the needed end alignments and securing structures to ensure that signal losses at an interface of aligned optical elements is minimal. Also, the processes described herein may ensure that outside conditions such as temperature changes or mechanical shocks do not significantly alter alignment or otherwise cause high signal losses for aligned tapered ends of optical elements. In some embodiments, the methods, apparatuses, and systems described herein may be used to align and secure optical elements of quantum devices, such as the quantum memory example described above, but also may more generally be used to align and secure optical elements of various other types of devices that take light as an input or that provide light signals as an output.

### Structures for Securing Aligned Optical Elements

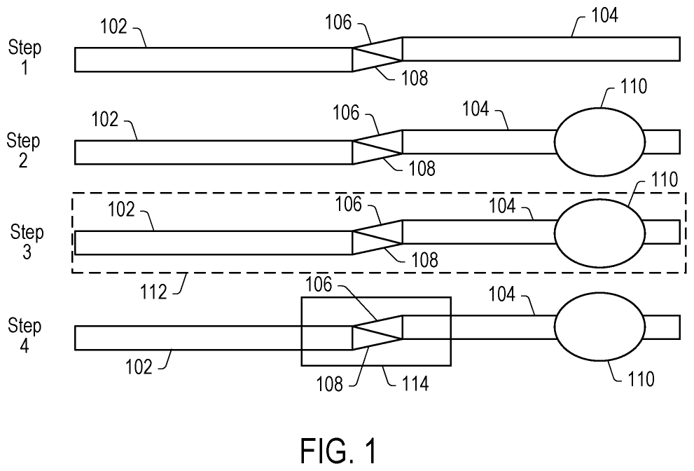

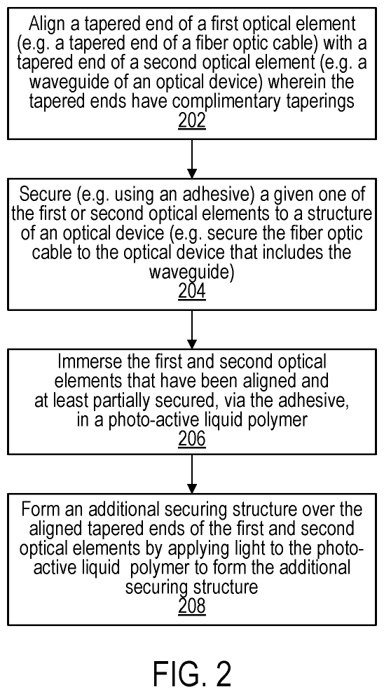

FIG. 1 is a block diagram illustrating a process of securing aligned tapered ends of optical elements that form an adiabatic coupling, wherein the process incudes securing at least one of the optical elements to an optical device structure via an adhesive and using a photo active material and photo-lithography to form an additional securing structure over the aligned tapered ends, according to some embodiments. Also, FIG. 2 is a flow diagram illustrating steps of a process for securing aligned tapered ends of optical elements using a securing structure formed using a photo active material and photo-lithography, according to some embodiments.

In some embodiments, a first step for forming a secure coupling between optical elements includes aligning a tapered end of a first optical element with a tapered end of a second optical element, wherein the tapered ends of the first and second optical elements have complimentary taperings. For example, at step 1 of FIG. 1 and block 202 of FIG. 2, tapered end 108 of optical element 102 is aligned with tapered end 106 of optical element 104.

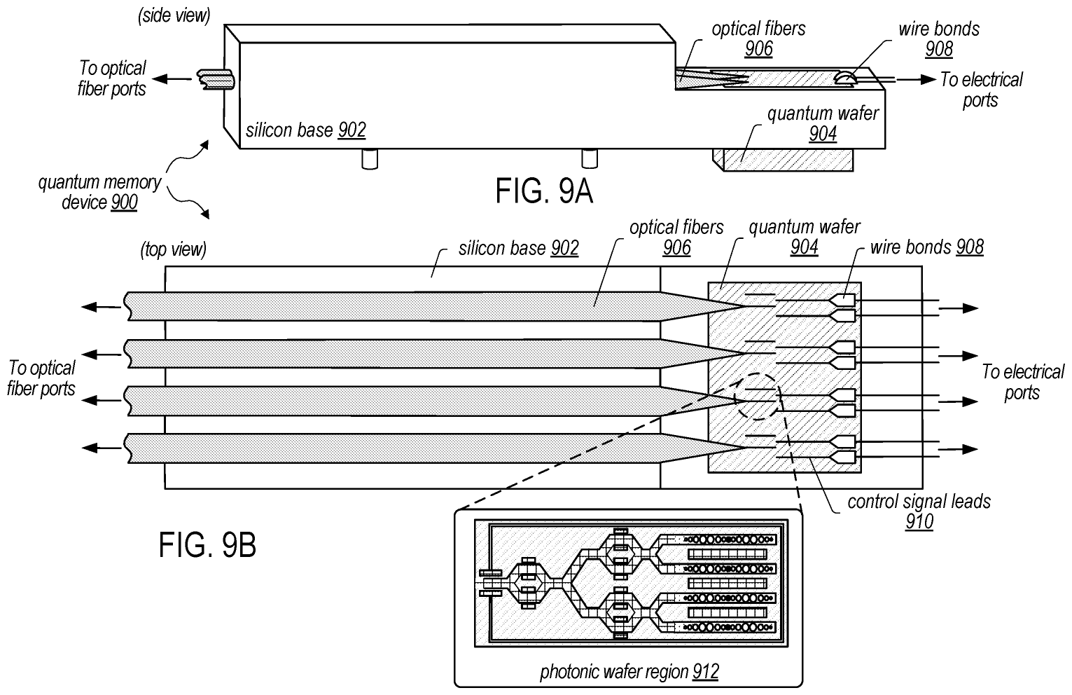

A next step for forming a secure coupling between optical elements includes securing a given one of the first or second optical elements to a structure of an optical device, wherein said securing is performed by applying an adhesive to the given first or second optical element to secure it to the structure of the optical device. For example, at step 2 of FIG. 1 and block 204 of FIG. 2, optical element 104 is secured to a structure of an optical device using adhesive 110. In some embodiments, optical element 102 may be a waveguide of an optical device, such as the waveguides shown on quantum wafer 904 in FIG. 9. Also, the optical element 104 may be an optical fiber 104 as shown in FIG. 9. In some embodiments, adhesive 110 may secure the optical element 104 to a base or other structure of the optical device such as silicon base 902 of quantum memory device 900 shown in FIG. 9B. In some embodiments, adhesive 110 may be an ultraviolet (UV) light curable resin, such as an epoxy, that hardens when UV light is applied. In some embodiments, adhesive 110 may secure a loose optical element, such as a fiber optic cable, to an optical device the loose optical element is being attached to. For example, a fiber optic cable attached to a quantum memory may first be secured by adhesive 110. The adhesive may provide good structure for securing the optical element, but may not be suitable for securing the alignment of the optical elements 102 and 104 through mechanical shocks or thermal shocks, as a few examples. Thus, as described for steps 3 and 4, an additional securing structure 114 may be added.

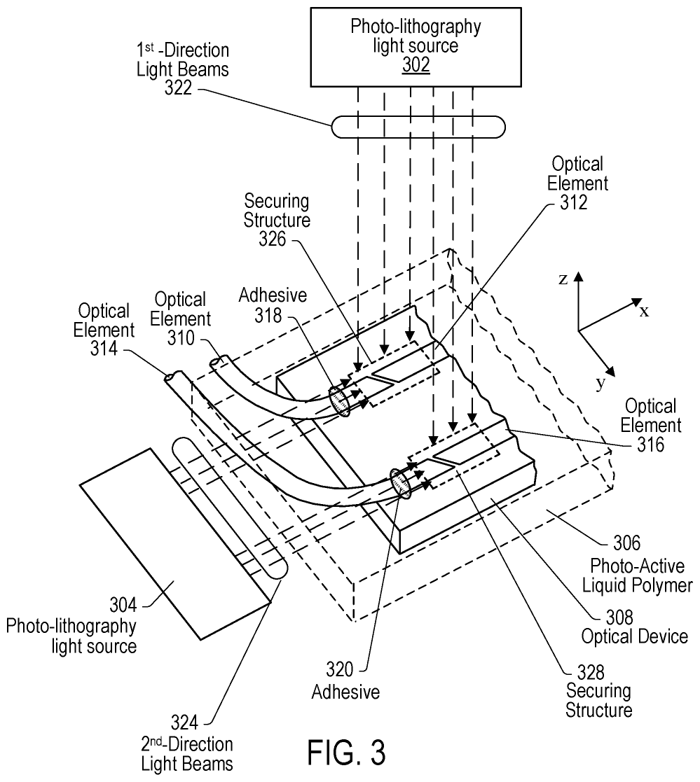

To form the additional securing structure, at step 3 of FIG. 1 and block 206 of FIG. 2, the aligned optical elements 102 and 104 with adiabatically coupled tapered ends 106 and 108 are immersed in a photo-active liquid polymer 112. Also, at step 4 of FIG. 1 and block 208 of FIG. 2, light is directed into the photo-active liquid polymer 112 to form the additional securing structure 114. For example, in some embodiments, two-photon lithography (as shown in FIG. 3) may be used. The additional securing structure 114 is formed over the aligned tapered ends of the first and second optical elements (e.g., ends 106 and 108) by applying photons of light to the photo-active liquid polymer to form the additional securing structure 114.

In some embodiments, the optical elements adiabatically coupled and secured via adhesive 110 and additional securing structure 114 may have a signal loss of approximately 0.5 dB or less. Also, the coupled aligned optical elements may be configured to be cooled to 70 degrees Kelvin or less without losing alignment (and therefore without appreciably increasing signal loss).

FIG. 3 is a block diagram illustrating photo-activated lithography being performed to form a securing structure over aligned tapered ends of adiabatically coupled optical elements, according to some embodiments.

In some embodiments, at least a portion of optical device 308 is immersed in photo-active polymer 306, wherein sets of coupled optical elements are secured to the optical device 308. For example, optical element 310 is secured to optical device 308 via adhesive 318 and is coupled to optical element 312, which is part of optical device 308. In a similar manner, optical element 314 is secured to optical device 308 via adhesive 320 and is coupled to optical element 316, which is part of optical device 308.

To form the securing structures 326 and 328 light beams 322 and light beams 324 are directed to the appropriate locations along the coupled optical elements where the securing structures are to be formed. In some embodiments, two-photon lithography is used. In such techniques, the photo-active liquid polymer 306 only hardens at points where two photons intersect, such as where light beams 322 directed in a first direction intersect light beams 324 directed in a second direction. In some embodiments, the first and second directions may be orthogonal to one another (for example vertical and horizontal). This technique may allow for precise placement of the securing structures 326 and 328 and/or precise forming of shapes of the securing structures 326 and 328, such as a cylindrical shape as shown in FIG. 5 or an inverse hour glass shape as shown in FIG. 6.

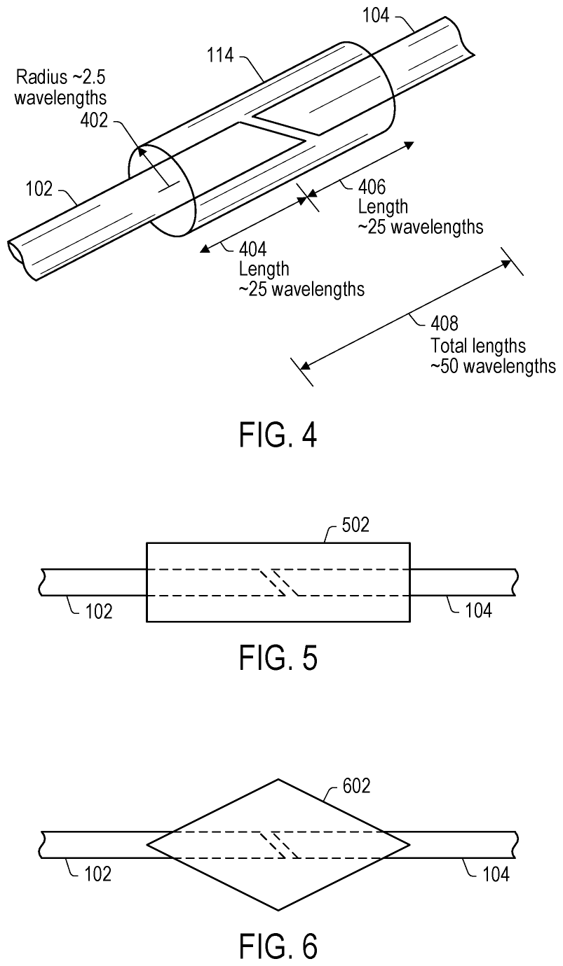

FIG. 4 is a perspective view of an example securing structure for securing adiabatically coupled optical elements formed using a photo active material and photo-lithography, according to some embodiments.

In some embodiments, a securing structure 114 may have a length that extends from the adiabatic coupling interface in either direction, such as shown in FIG. 4 for lengths 404 and 406. In some embodiments lengths 404 and 406 may be centered on the adiabatic coupling interface and have a combined length 408. In some embodiments, lengths 404 and 406 may be approximately 50 or less wavelengths long, such as approximately 25 wavelengths long, wherein the wavelength referred to in the measurement of the lengths 404 and 406 is a wavelength of light transmitted via optical elements 102 and 104. Also, the securing structure 114 may have an overall length 408 of approximately 100 wavelengths or less, and in some embodiments have a 50 wavelengths overall length. Though in some embodiments, other length and diameter dimensions may be used. In some embodiments, the diameter and/or length may be selected to provide sufficient structural support, without causing appreciable discontinuities that affect the light being transmitted via optical elements 102 and 104. For example, an abrupt and significant change in diameter of a shielding of the optical elements 102 and/or 104 may cause a nick that may scatter light. In some embodiments, the thickness of securing structure 114 is selected to provide sufficient structural support without causing light scattering, for example due to nicks. For example, in some embodiments radius 402 may be approximately 10 wavelengths or less, such as approximately 2.5 wavelengths and an outer diameter of securing structure 114 may be approximately 20 wavelengths or less, such as approximately 5 wavelengths in diameter.

FIG. 5 illustrates a side-view of an example securing structure having a cylindrical outer shape and FIG. 6 illustrates a side-view of an example securing structure having an inverse hour-glass shape, according to some embodiments.

For example, securing structure 114 may have a cylindrical shape 502 as shown in FIG. 5 or securing structure 114 may have an inverse hour glass shape 602 as shown in FIG. 6. For example, a securing structure 114 may have a cylindrical shape 502 centered on the aligned tapered ends of the first and second optical elements 102 and 104. Also, as another example, a securing structure 114 may have a varying radius that forms an inverse hour glass shape 602, wherein a thicker center portion of the inverse hour glass shape is aligned with the aligned tapered ends (e.g., 106 and 108) of the first and second optical elements 102 and 104, and wherein the thickness of the additional securing structure tapers down in either direction from the thicker center portion, such as shown in FIG. 6.

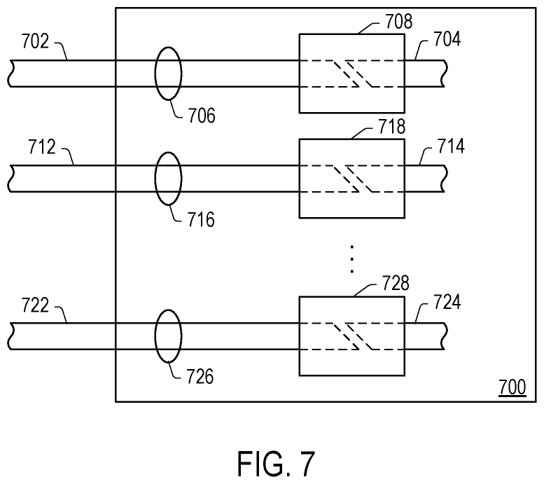

In some embodiments, multiple pairs of optical elements connected to a same optical device may be secured with securing structures as described herein. For example, FIG. 7 illustrates a top view of an optical device comprising a set of optical elements adiabatically coupled to another set of optical elements, wherein securing structures formed via photo-activated lithography are securing the sets of adiabatically coupled optical elements, according to some embodiments.

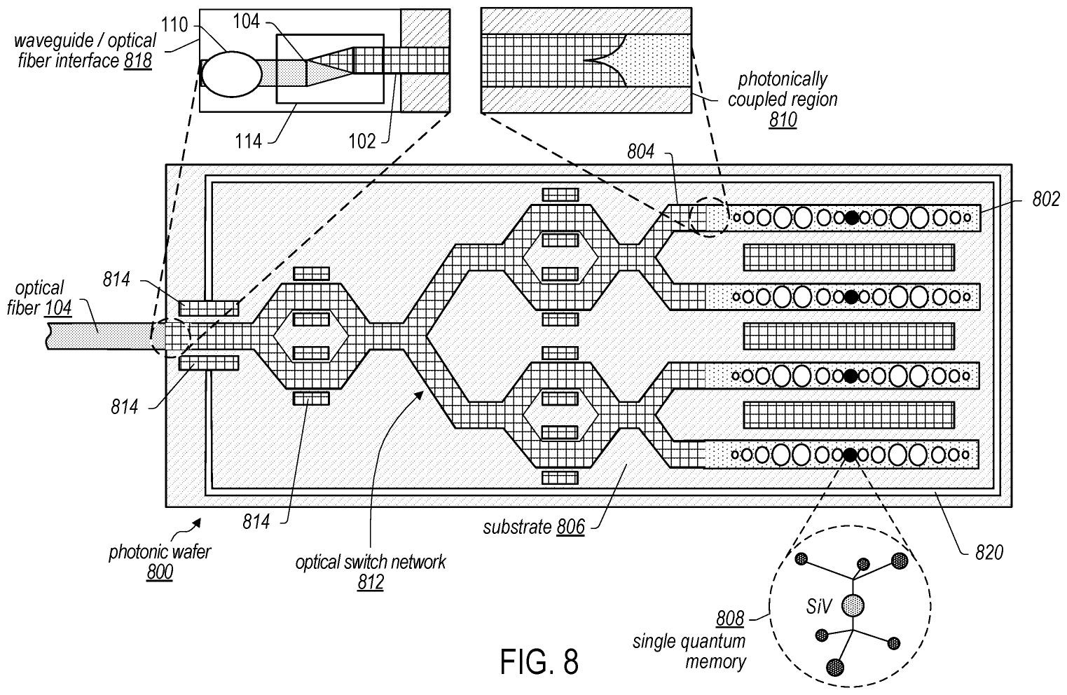

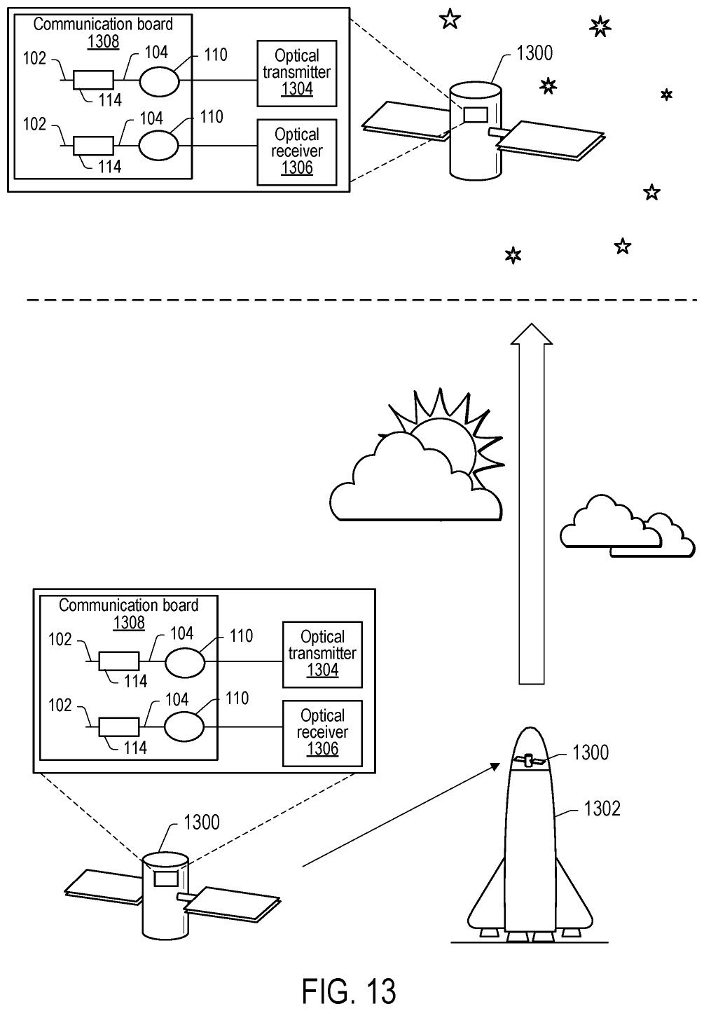

In some embodiments, optical device 700 includes optical elements 704, 714, and 724, which are being coupled to optical elements 702, 712, and 722, respectively. The optical elements 702, 712, and 722 are secured to optical device 700 via adhesive applications 706, 716, and 726, respectively. Also, the pairs of optical elements are secured at the adiabatic coupling region via respective securing structures 708, 718, and 728, which may be formed using photo-activated lithography, such as described in FIG. 3. More particularly, as further described with regard to FIG. 8, optical device 700 may be a photonic wafer that is part of a quantum memory or quantum repeater, and the optical elements being coupled to optical device 700 may be fiber optic cables connected to the photonic wafer. As an example, a securing structure as described herein may be used to secure a fiber optic cable to a waveguide of an optical device, such as at a waveguide/optical fiber interface. Also, as shown in FIG. 13, a securing structure as described herein may be used to secure optical connections, such as in satellites that undergo mechanical vibrations and temperature changes when launched into space.

FIG. 8 illustrates an example implementation of an optical device into which light may be transported via adiabatically coupled optical elements secured using a securing structure formed using photo-activated lithography, according to some embodiments.

In some embodiments, photonic wafer 800 may be used to transfer light between optical fiber 102 and respective quantum memories which may be patterned into photonic waveguide layer 802. In some embodiments, a process for fabricating at least some regions of photonic wafer 800 may use a starting stack, comprising substrate 806, and photonic waveguide layer 802, and photonic waveguide layer 804, may be patterned, resulting in the components shown in FIG. 8. For example, photonically coupled region 810 may represent a region of photonic wafer 800 at which light may be transferred between photonic waveguide layer 804 and photonic waveguide layer 802. As shown in FIG. 8, the two photonic waveguide layers of photonically coupled region 810 have been tapered to allow for evanescent coupling. In contrast, waveguide/optical fiber interface 818 may represent a region of photonic wafer 800 at which light may be transferred between optical fiber 104 and photonic waveguide layer 804. In some embodiments, optical fiber 104 may interface with photonic waveguide layer 804 using adiabatic coupling, wherein tapered end 108 of optical fiber 104 contacts tapered end 106 of waveguide element 102. In some embodiments, van der waals attraction forces may initially hold the tapered ends 106 and 108 together while securing structure 114 is being applied. Also, adhesive 110 may secure optical fiber 104 to substrate 806.

In some embodiments, an optical switch network, such as optical switch network 812, may be patterned into a material used to fabricate photonic waveguide layer 804. Optical switch network 812 may be used to route photons between waveguide/optical fiber interface 818 and photonically coupled region 810. It may be advantageous to design photonic wafer 800 such that a single optical fiber services many individual quantum memories, as shown in FIG. 8, and addressing incoming photons using optical switch network 812 enables photonic wafer 800 to be a densely packaged device. In some embodiments, patterning optical switch network 812 into photonic waveguide layer 804 may be done in various ways. For example, in some embodiments in which the material for photonic waveguide layer 804 is selected for its electrooptic properties, it may be advantageous to maintain the photon in photonic waveguide layer 804 until the moment it is necessary to transfer the light into photonic waveguide layer 802 (e.g., storage in a given quantum memory patterned into photonic waveguide layer 802).

Photonic wafer 800 may be configured to receive photons in a superposition state (e.g., via optical fiber 104) to an on-wafer storage (e.g., respective quantum memories patterned into photonic waveguide layer 802 such as single quantum memory 808). In some embodiments, quantum memories patterned into photonic waveguide layer 802 may be coupled to nanophotonic cavities, such as the nanophotonic cavity shown in single quantum memory 808, which illustrates a silicon vacancy in diamond structure. In such embodiments, the silicon vacancies are embedded into nanophotonic cavities within photonic waveguide layer 802, which may be diamond in such cases. A silicon vacancy in diamond structure, such as single quantum memory 808 demonstrated in FIG. 8, may act as a quantum memory, and a corresponding nanophotonic cavity (e.g., patterned with diamond, etc.) may allow light to interface with said silicon vacancy in diamond structure. In other embodiments, however, quantum memories patterned into photonic waveguide layer 802 may resemble other structures embedded into photonic waveguide layer 802, such as nitrogen-vacancy in diamond, trapped atoms, ensemble doped crystals, atomic vapors, silicon carbide emitters, single rare earth dopants, trapped ions, superconducting qubits, quantum dots in gallium arsenide, defect centers in silicon or other semiconducting materials, etc. Furthermore, different types of quantum memories may be embedded into respective portions of photonic waveguide layer 802, and in some embodiments as shown in FIG. 9B, different materials may be used to respective photonic wafer regions (e.g., photonic wafer region 912) of quantum wafer 904, allowing respective photonic waveguide layers to be patterned according to a given quantum memory architecture.

In some embodiments wherein photonic wafer 800 may be used within a quantum memory device, such as quantum memory device 900 (e.g., for use as a quantum network node for quantum entanglement distribution), photonic wafer 800 may be configured to store a first received entangled particle of a first pair of entangled particles in a first single quantum memory 808 of photonic waveguide layer 802 and also store a second received entangled particle of a second pair of entangled particles in a second single quantum memory 808 of photonic waveguide layer 802.

Photonic wafer 800 (or a quantum measurement device connected to photonic wafer 800 either inside or outside of quantum memory device 900) may further be configured to perform one or more joint measurements on the first and second particles without collapsing superposition states of the first and second entangled particles. The joint measurements may determine a correlation relationship between the superposition states of the entangled particles such that entanglement can be extended between the pairs of entangle particles.

In some embodiments, quantum memories within photonic waveguide layer 802 may be heralded, meaning that when a particle arrives and is stored in a single quantum memory such as single quantum memory 808, a quantum measurement device issues a heralding signal announcing the arrival of the particle. In some embodiments, such a heralding signal may be issued via optical fiber 104, and may be used to trigger operation of an optical switch within optical switch network 812 in order to align the next pathway within optical switch network 812 for routing the next incoming particle to a respective quantum memory of photonic waveguide layer 802. Also, while not shown, in some embodiments, photonic wafer 800 may comprises multiple sets of optical switch networks and associated waveguide layers 802 and quantum memories 808. For example, each of the optical fibers 702, 712, and 722, shown in FIG. 7, may connect to an optical switching network with associated wave guides and quantum memories as shown in FIG. 8.

In some embodiments, photonic wafer 800 may further include a conversion interface (e.g., nonlinear optics elements 814). For example, in some embodiments, a conversion interface (e.g., nonlinear optics elements 814) may convert a transmission frequency of a received photonic particle to a different frequency prior to storage of the particle in a given quantum memory within photonic waveguide layer 802. For example, in some embodiments, fiber optical links (e.g., optical fiber 104) may transmit photonic particles using different frequencies and such variations may be adjusted via a conversion interface of photonic wafer 800. As another example, particles received at photonic wafer 800 via optical ground stations and/or particles received at photonic wafer 800 via fiber links may be transmitted at different wavelengths and a conversion interface of photonic wafer 800 may convert the wavelength of the received particles to a wavelength used by a given single quantum memory, such as single quantum memory 808, to store quantum particles in said memory. In some embodiments, nonlinear optics elements 814, as shown in FIG. 8, may also provide phase shifting, amplitude modulation, and/or other functionalities with respect a received particle, and/or any other interfacing property that may be required in terms of manipulating an incoming particle before routing the particle to storage on photonic wafer 800. Furthermore, as shown in FIG. 8, nonlinear optics elements 814 may also be fabricated using a same material as the material used to fabricate photonic waveguide layer 804, according to some embodiments.

FIGS. 9A-9B illustrate an example implementation of an optical device, such as a quantum memory device (e.g., a quantum repeater), into which light may be transported via adiabatically coupled optical elements secured using a securing structure formed using photo-activated lithography, according to some embodiments.

In some embodiments, quantum memories may provide a method of receiving, storing, and providing quantum information. In some cases, quantum memories may be deployed for use in large-scale optical fiber networks and/or quantum entanglement networks, for example as quantum repeaters, that store and effectively connect distributed entangled particles to provide secure, long-distance communications. In such applications, quantum memory device 900 may function to control the tuning (e.g., adjustments to the local electrical, optical, thermal, electromechanical environment) of quantum memories housed within quantum memory device 900.

In some embodiments, a quantum memory device, such as quantum memory device 900, may comprise quantum memories and quantum memory control devices. Note that for ease of illustration, some embodiments of the following description are given in terms of quantum memory device 900 resembling a quantum repeater. However, in some embodiments, a quantum memory device, as described herein in FIGS. 9A-9B, may be used for other purposes, such as storing quantum information locally at a given location. For example, in some situations, quantum memory device 900 may be used to store quantum information (such as in a cache) that is used by multiple locally situated quantum computers. As seen in FIGS. 9A-9B, quantum wafer 904 may house quantum memories via photonic wafer regions such as photonic wafer region 912. Photonic wafer region 912 may resemble photonic wafer 800 and the functionalities for photonic wafer 800 (e.g., routing light between an optical fiber and respective quantum memories of photonic wafer 800) described herein.

Quantum memory control devices of quantum memory device 900 may, for example, provide mechanisms for receiving and routing quantum information (e.g., entangled particles) to be stored in the quantum memories of quantum wafer 904. In another example, quantum memory control devices may provide mechanisms for receiving, sending, emitting, and/or controlling optical and/or electrical control signals to, or from, quantum wafer 904. In yet another example, quantum memory control devices may modify the behavior of the quantum memories on quantum wafer 904 via the use of low-frequency control signals (e.g., microwave, RF, and/or DC control signals) that may induce strain on the quantum memories. Quantum memory control devices may additionally control heat and/or gas flow onto quantum wafer 904. Quantum memory control devices may also be used to deliver electrical control signals that result in the creation of local electromechanical strain fields near the quantum memories of quantum wafer 904, according to some embodiments. Such electromechanical strain fields may, for example, enable for the tuning of optical and/or spin properties of quantum memories on quantum wafer 904 for improved performance and operation of said quantum memories. This may be referred to as strain tuning of the quantum memories, according to some embodiments.

The placements and interactions of the quantum memories and some quantum memory control devices within quantum memory device 900 may resemble embodiments shown in the side and top view of quantum memory device 900 in FIGS. 9A and 9B, respectively. In some embodiments, quantum memory device 900 may additionally include optical fiber ports and/or electrical ports that provide access points between optical fiber cables, control signal leads, electrical wires, electrical cables, etc., located external to quantum memory device 900, and quantum wafer 904.

In some embodiments, quantum memory device 900 may include a base material, such as silicon base 902, onto which quantum wafer 904 may be bonded/attached. In some embodiments, as shown in FIGS. 9A-9B, the base material is silicon. However, it should be understood by a person having ordinary skill in the art that the base material could be another material that provides similar functionalities as silicon base 902 (e.g., another semiconducting material). In some embodiments, optical fibers, such as optical fibers 906, may be inserted into grooves or through-holes embedded inside silicon base 902. For example, optical fibers 104 as shown in FIG. 1 may be inserted into grooves or through-holes embedded inside silicon base 902. As shown in FIG. 9B, optical fibers 906 may be coupled to quantum wafer 904 and to optical fiber ports of quantum memory device 900. In some embodiments, an adhesive 110 (as shown in FIG. 1) may secure the optical fibers to silicon base 902 and a securing structure 114 (as shown in FIG. 1) may secure the optical fibers to the wave guides of the quantum wafer 904. Silicon base 902 may house several rows of optical fibers, according to the depth of silicon base 902, that are fit into grooves. Silicon base 902 may also be bonded (e.g., soldered) to quantum wafer 904 (e.g., via indium bumps). In some embodiments, optical fibers 906 may be referred to as “tapered” optical fibers due to their needle-point shape, as shown in FIG. 9B.

In some embodiments, wire bonds, such as wire bonds 908 (e.g., soldering points), may be used to connect control signal leads 910 to electrical ports of quantum memory device 900. Electrical connections to quantum wafer 904 may also be fabricated using a “flip chip” method, according to some embodiments. In such embodiments, a “flip chip” layer may enable routing of electrical signals with complex topologies to quantum wafer 904. In some embodiments, electrical control signals, such as microwave or RF frequency control signals, may be used to control the state (e.g., state change) of a given quantum memory. In some embodiments in which the quantum memories on quantum wafer 904 are nanophotonic cavities (e.g., single quantum memory 808), DC or low-frequency AC electric fields may be used to tune the color center resonances of such nanophotonic cavities. In some embodiments, such electrical control signals may also be configured such that cross talk and excess heating of the quantum memories on quantum wafer 904 may be avoided. In some embodiments, electrical control signals, such as DC, RF, and/or microwave signals, may be delivered to the quantum memories of quantum wafer 904 via micro-patterned electrical lines (e.g., coplanar waveguides, capacitors, etc. that may be made of semiconducting and/or superconducting materials) on both silicon base 902 and quantum wafer 904 (e.g., control signal leads 910). For example, such micro-patterned electrical lines may be patterned using photonic waveguide layer 804.

In some embodiments, quantum wafer 904 may also include other types of devices on the same wafer such that quantum wafer is a densely packaged device. For example, photon detectors, frequency conversion nonlinear optics (e.g., nonlinear optics elements 814), and/or light sources on chip may be fabricated. In some embodiments, electromagnets may be provided on quantum wafer 904 (e.g., small, “on-chip” electromagnets) in order to finetune a local magnetic field environment of the quantum memories. Such “on-chip” electromagnets may be patterned onto quantum wafer 904 via photolithography and/or electron beam lithography fabrication processes.

In some embodiments, quantum memories on quantum wafer 904 may resemble single quantum memory 808 and functionalities and/or the various types of quantum memory described above with regard to single quantum memory 808. Quantum wafer 904 may comprise a “host material” for quantum memories (photonic waveguide layer 802), and may be micro-patterned for electrical lines that allow electrical control signals to reach the quantum memories, according to some embodiments. The materials chosen for quantum wafer 904 may vary based on the type of quantum memory it hosts. For example, quantum wafer 904 may resemble a nanophotonic crystal interface for a type of quantum memory such as a diamond SiV color center. However, quantum wafer 904 may resemble any nanophotonic cavity (e.g., nanophotonic crystal cavities, ring resonators, plasmonic cavities, etc.) or Fabry Perot cavity that provides an optical interface for quantum memories of quantum memory device 900, when used to house other types of quantum memories. The nanophotonic cavities may be attached to a variety of substrates, such as diamond, LiNbO, or silicon, as described herein.

Once the type of nanophotonic cavity is chosen, quantum memory control devices of interface layer 906 may be used to match the frequency of the nanophotonic cavity to the given quantum emitter (e.g., an entangled particle source). For example, the quantum memory control devices may be used to perform optical tuning (e.g., refractive index shift), electromechanical deformation tuning, and/or gas (e.g., N₂ gas) deposition tuning onto the nanophotonic cavities. In addition, control signal leads 910 may provide electrical control signals to, and/or from, the quantum memories and may be attached to quantum wafer 904 via wire bonds 908. In some embodiments, control signal leads 910 may be routed to respective nonlinear optics elements 814 via electrical routing paths such as electrical routing path 820 (e.g., electrical connections that have been patterned onto photonic wafer 800, such as gold pads).

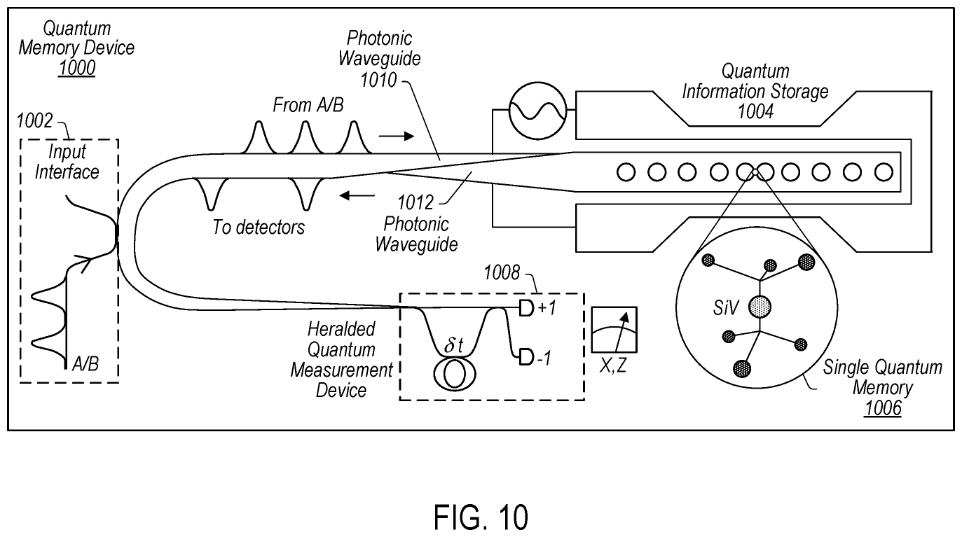

FIG. 10 illustrates an example of a quantum memory device, wherein quantum information storage device(s) of the quantum memory device may be provided photons through adiabatically coupled optical elements secured using a securing structure formed using photo-activated lithography, according to some embodiments.

Quantum memory device 1000 includes in input interface 1002 that receives particles in a superposition state to quantum information storage 1004, which comprises single quantum memory 1006, and may be configured to couple to heralded quantum measurement device 1008 via photonic waveguide layer 1012. For example, single quantum memory 1006 illustrates a silicon vacancy in diamond structure. Though in some embodiments, other structures such as: nitrogen-vacancy in diamond, trapped atoms, ensemble doped crystals, atomic vapors, silicon carbide emitters, single rare earth dopants, trapped ions, superconducting qubits, quantum dots in gallium arsenide, etc. may be used. Furthermore, input interface 1002 illustrates an embodiment of a time-bin qubit encoding conversion module, however other embodiments with other input interface configurations may be used, including wavelength or mode matching.

In some embodiments, input interface 1002 may be configured to couple with photonic waveguide layer 1010, for example using an adiabatic coupling of tapered ends and securing structures as shown in FIG. 1 For example, input interface 1002 may receive an optical fiber 104 and adiabatically couple the optical fiber 104 to an optical element 102 of photonic waveguide 1012. This may be done using an adhesive 110 and securing structure 114 as shown in FIG. 1.

In some embodiments, quantum memory device 1000 may be configured to store quantum information corresponding to a first received entangled particle of a first pair of entangled particles in a first single quantum memory 1006 of quantum information storage 1004 and also store quantum information corresponding to a second received entangled particle of a second pair of entangled particles in a second single quantum memory 1006 of quantum information storage 1004. Quantum memory device 1000 may further be configured to perform one or more joint measurements on the first and second particles via heralded quantum measurement device 1008 without collapsing superposition states of the first and second entangled particles. The joint measurements may determine a correlation relationship between the superposition states of the entangled particles such that entanglement can be extended between the pairs of entangle particles.

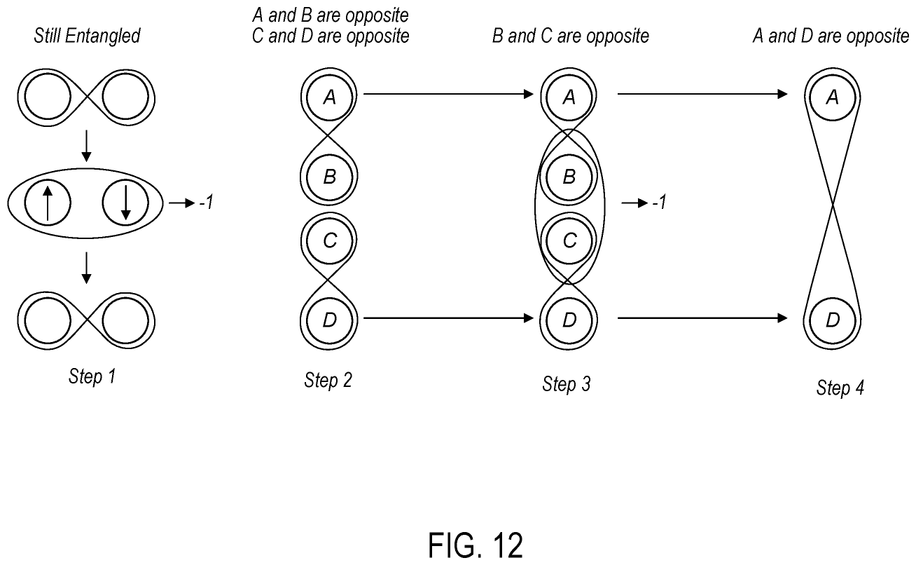

Quantum memory device 1000 may be heralded, meaning that when a particle arrives to quantum memory device 1000, the quantum measurement device 1008 (or other device coupled to quantum information storage 1004 of quantum memory device 1000) issues a heralding signal announcing the arrival of the particle. In some embodiments, such a heralding signal may be used to operate an optical switch to align the switch such that the quantum memory receives a next particle from an entangled particle source with which quantum entanglement is to be distributed. Furthermore, when the second particle arrives at quantum memory device 1000 from the entangled particle source, a second heralding signal may be issued. The second heralding signal may then cause joint measurements to be performed on the first and second particles stored in quantum memory device 1000. Furthermore, the joint measurements may extend the entanglement (see also description pertaining to FIG. 12 herein). In some embodiments, quantum measurement device 1008 may perform heralding measurements and joint measurements, or in some embodiments, different quantum measurement devices 1008 may be used to perform heralding measurements and joint measurements on received particle pairs. In some embodiments, the heralding function may be performed by a quantum non-destruction measuring device that can detect a particle (e.g., photon) entering quantum memory device 1000 without causing the particle to be collapsed out of the superposition state.

In some embodiments, quantum memory device 1000 may further include a conversion interface. For example, in some embodiments, the conversion interface may convert a transmission frequency of a received particle to a different frequency. For example, in some embodiments, fiber optic links may transmit particles using different frequency wavelengths and such variations may be adjusted via a conversion interface of quantum memory device 1000. In some embodiments, the conversion interface may be located proximate to quantum memory device 1000, but may not necessarily be included in quantum memory device 1000.

In some embodiments, quantum memory device 1000 (or sets of quantum memories) may store redundant sets of particles for use in generating quantum entanglement that is to be distributed. In such embodiments, the quantum memor(ies) may perform error correction by comparing joint measurement results for multiple sets of particles. Such error correction may function as entanglement purification, in some embodiments. Also, parties at the endpoints connected via the redundantly distributed quantum entanglement may perform error correction.

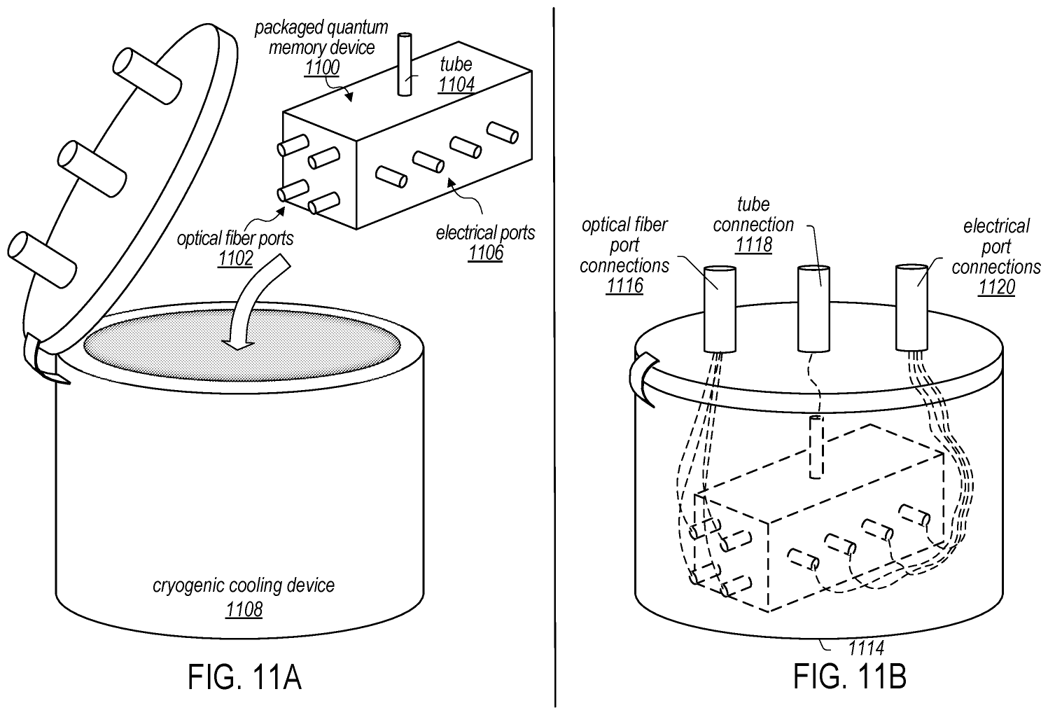

FIGS. 11A-11B illustrate installation of an optical device, such as a quantum memory device, comprising adiabatically coupled optical elements secured using a securing structure formed using photo-activated lithography, wherein the optical device is being installed into a cryogenic cooling device, according to some embodiments.

In some embodiments, one or more optical devices, such as packaged quantum memory device 1100, may be installed in a cryogenic cooling device, such as cryogenic cooling device 1108. Cryogenic cooling device 1108 may resemble a dilution refrigerator, cryogenic refrigerator, cryogenic cooling element, cryogenic cooler, and/or any system that may cool down to and maintain cryogenic temperatures over a period of time, according to some embodiments. It should be understood by someone having ordinary skill in the art that cryogenic cooling device 1108 is configured to operate at different temperatures and/or within different temperature ranges, such as within cryogenic temperature ranges and within higher temperature ranges (e.g., approximately room temperature, above room temperature, etc.), and is additionally able to stabilize at any given temperature within a given temperature range. As shown in FIG. 11B, packaged quantum memory device 1100 may be completely enclosed within cryogenic cooling device 1108 as part of an installation process at a destination location (e.g., wherein the destination location may be a location of a quantum network node for a quantum entanglement distribution service).

In some embodiments, installation of packaged quantum memory device 1100 into cryogenic cooling device 1108 may include coupling optical fiber and electrical connectors to respective optical fiber and electrical ports of packaged quantum memory device 1100, such as optical fiber ports 1102 and electrical ports 1106. Installation of packaged quantum memory device 1100 into cryogenic cooling device 1108 may additionally include routing a gas tube, such as gas tube 1104, to and/or through a gas tube connection, according to some embodiments.

In some embodiments, the additional securing structure 114 (as shown in FIG. 1) over the aligned tapered ends (106 and 108) of the first and second optical elements (102 and 104) is configured to experience temperature cycles from room temperatures to cryogenic temperatures while maintaining the alignment of the tapered ends of the first and second optical elements. Also, the additional securing structure 114 (as shown in FIG. 1) over the aligned tapered ends (106 and 108) of the first and second optical elements (102 and 104) is configured to experience mechanical shocks due to dropping or vibrations during transit of an optical device comprising the aligned and secured first and second optical elements.

FIG. 12 is an example diagram illustrating how entanglement is extended by performing joint measurements of received particles of respective sets of entangled particles distributed via fiber optic network links, such as to/from quantum memory devices, according to some embodiments.

In some embodiments, joint measurements as shown in FIG. 12 may be performed for photons stored in quantum memories (e.g., single quantum memory 1006) in a quantum memory device, such as quantum memory device 1000. For example, at step 1, a joint measurement is performed that measures two particles (e.g., photons) in such a way as that the joint measurement only determines if the two particles are the same or opposite (e.g., in the same quantum state or not). This is done without revealing information about the individual particles. Then, at step 2, the entangled pairs are defined by their correlations, e.g., opposite or the same. In the example shown in FIG. 12, both A/B and C/D are entangled such that they are opposites. Next, at step 3 a joint measurement is performed on B/C with an outcome (e.g., opposite or same), which is opposite in the example case shown in FIG. 12. This tells A that its compliment is the opposite D's compliment, allowing A and D to infer they are opposites. Then, using this information at step 4 A/D the particles are now entangled such that they are always in the opposite state. In some embodiments, the joint measurements may be performed using a local two-qubit gate between B and C (e.g., a CNOT gate) and may further include measuring each bit individually. This can be understood as an entangling operation and a measurement, or conversely as a single measurement in an “entangled basis.” When the joint measurements are performed in this way, the results reveal information about the correlations between particles, such as particles B and C, but not information about the particles themselves. This is due to the entanglement generated by the two-qubit operation. Such joint measurements may be performed at a quantum measurement device, according to some embodiments.

FIG. 13 illustrates an example implementation of an optical device, such as in a satellite communication system, which may include adiabatically coupled optical elements secured using a securing structure formed using photo-activated lithography, according to some embodiments.

While the examples described in FIGS. 8-12 were related to quantum entanglement distribution, quantum memories, quantum repeaters, etc., in some embodiments, securing structures, such as adhesive 110 and structure 114 formed used photo-activated lithography, as described herein, may be used in more general applications, such as securing optical elements in optical communications networks.

As an example, FIG. 13 illustrates satellite 1300 that includes a communications board 1308 coupled to an optical transmitter 1304 and/or an optical receiver 1306. Optical element 104 of optical transmitter 1304 and optical element 104 of optical receiver 1306 may be adiabatically coupled with respective optical elements 102 of communication board 1308. The adiabatically coupled optical elements are secured using respective adhesives 110 and additional securing structures formed using photo-activated lithography 114, such as described in FIG. 1 and throughout the detailed description.

The securing structures 110 and 114 may secure the adiabatic couplings between the optical elements despite vibrations and/or temperature changes. For example, satellite 1300 may be launched into space via rocket 1300, and the securing structures 110 and 114 may secure the adiabatic couplings between the optical elements of the communication board 1308 and the optical transmitter 1304 and optical receiver 1306 during the launch process and thereafter.

### Illustrative Computer System

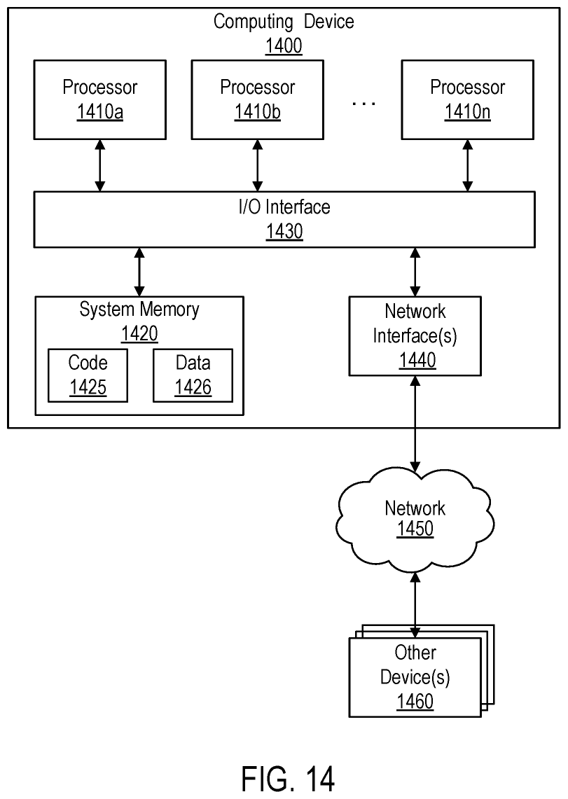

FIG. 14 is a block diagram illustrating an example computing device that may be used in at least some embodiments.

FIG. 14 illustrates such a general-purpose computing device 1400 as may be used in any of the embodiments described herein. In the illustrated embodiment, computing device 1400 includes one or more processors 1410 coupled to a system memory 1420 (which may comprise both non-volatile and volatile memory modules) via an input/output (I/O) interface 1430. Computing device 1400 further includes a network interface 1440 coupled to I/O interface 1430.

In various embodiments, computing device 1400 may be a uniprocessor system including one processor 1410, or a multiprocessor system including several processors 1410 (e.g., two, four, eight, or another suitable number). Processors 1410 may be any suitable processors capable of executing instructions. For example, in various embodiments, processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA. In some implementations, graphics processing units (GPUs) may be used instead of, or in addition to, conventional processors.

System memory 1420 may be configured to store instructions and data accessible by processor(s) 1410. In at least some embodiments, the system memory 1420 may comprise both volatile and non-volatile portions; in other embodiments, only volatile memory may be used. In various embodiments, the volatile portion of system memory 1420 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1420 as code 1425 and data 1426.

In some embodiments, I/O interface 1430 may be configured to coordinate I/O traffic between processor 1410, system memory 1420, and any peripheral devices in the device, including network interface 1440 or other peripheral interfaces such as various types of persistent and/or volatile storage devices. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computing device 1400 and other devices 1460 attached to a network or networks 1450, such as other computer systems or devices as illustrated in FIG. 1 through FIG. 13, for example. In various embodiments, network interface 1440 may support communication via any suitable wired or wireless general data networks, such as types of Ethernet network, for example. Additionally, network interface 1440 may support communication via telecommunications/telephony networks such as analog voice networks or digital fiber communications networks, via storage area networks such as Fibre Channel SANs, or via any other suitable type of network and/or protocol.

In some embodiments, system memory 1420 may represent one embodiment of a computer-accessible medium configured to store at least a subset of program instructions and data used for implementing the methods and apparatus discussed in the context of FIG. 1 through FIG. 13. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1400 via I/O interface 1430. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1400 as system memory 1420 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1440. Portions or all of multiple computing devices such as that illustrated in FIG. 14 may be used to implement the described functionality in various embodiments; for example, software components running on a variety of different devices may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or

DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A method of forming a secure coupling between optical elements, the method comprising:
aligning a tapered end of a first optical element with a tapered end of a second optical element, wherein the tapered ends of the first and second optical elements have complimentary taperings;
securing, a given one of the first or second optical elements to a structure of an optical device, wherein said securing is performed by applying an adhesive to the given first or second optical element to secure it to the structure of the optical device;
immersing the first and second optical elements that have been aligned and at least partially secured via the adhesive in a photo-active liquid polymer; and
forming an additional securing structure over the aligned tapered ends of the first and second optical elements by applying photons of light to the photo-active liquid polymer to form the additional securing structure.

2. The method of claim 1, wherein the aligning of the tapered ends of the first and second optical elements forms an adiabatic coupling between the first and second optical elements.

3. The method of claim 1, wherein the first and second optical elements comprise:
a fiber optic cable; and
a waveguide of an optical device.

4. The method of claim 3, further comprising:
performing said aligning, said immersing, and said forming the additional securing structure for a plurality of fiber optical cables that couple with respective ones of a plurality of waveguides of the optical device.

5. The method of claim 4, wherein said performing said aligning, said immersing, and said forming the additional securing structure are performed in parallel for at least a portion of the waveguides and corresponding optical fibers of the optical device.

6. The method of claim 1, wherein applying the photons of light to the photo-active liquid polymer to form the additional securing structure is performed using a two-photon lithography process.

7. The method of claim 1, wherein the additional securing structure over the aligned tapered ends of the first and second optical elements is configured to experience temperature cycles from room temperatures to cryogenic temperatures while maintaining the alignment of the tapered ends of the first and second optical elements.

8. The method of claim 1, wherein the additional securing structure over the aligned tapered ends of the first and second optical elements is configured to experience mechanical shocks due to dropping or vibrations during transit of an optical device comprising the aligned and secured first and second optical elements.

9. An optical coupling structure comprising:
adhesive placed to secure a first optical element to a structure of an optical device including a second optical element, wherein tapered ends the first optical element and the second optical element have been aligned; and
an additional securing structure formed over the aligned tapered ends of the first and second optical elements, wherein the additional securing structure is formed by applying photons of light to a photo-active liquid polymer in which the aligned tapered ends of the first and second optical elements have been immersed.

10. The optical coupling structure of claim 9, wherein the second optical element is a waveguide of the optical device and the first optical element is a fiber optic cable coupled to the optical device.

11. The optical coupling structure of claim 9, wherein the tapered ends of the first and second optical elements form an adiabatic coupling between the first and second optical elements.

12. The optical coupling structure of claim 9, wherein the adhesive comprises an epoxy placed in a liquid form over a casing of the first optical element and the structure of the optical device, wherein the epoxy hardens to secure the first optical element in place with respect to the structure of the optical device.

13. The optical coupling structure of claim 9,
wherein the additional securing structure has a length along respective axis of the first and second optical elements that extends for approximately 50 or less wavelengths in either direction from the aligned tapered ends of the first and second optical elements for a total length of approximately 100 or less wavelengths, wherein the wavelengths correspond to wavelengths of light transmitted via the coupled first and second optical elements.

14. The optical coupling structure of claim 9,
wherein the additional securing structure has a radius orthogonal to respective axis of the first and second optical elements that extends for approximately 10 wavelengths or less in either direction from the aligned tapered ends of the first and second optical elements for a total diameter of approximately 20 wavelengths or less, wherein the wavelengths correspond to wavelengths of light transmitted via the coupled first and second optical elements.

15. The optical coupling structure of claim 9,
wherein the additional securing structure has a varying radius that forms an inverse hour glass shape, wherein a thicker center portion of the inverse hour glass shape is aligned with the aligned tapered ends of the first and second optical elements, and wherein the thickness of the additional securing structure tapers down in either direction from the thicker center portion.

16. The optical coupling structure of claim 9,
wherein the additional securing structure has a cylindrical shape centered on the aligned tapered ends of the first and second optical elements.

17. The optical coupling structure of claim 9, further comprising:
a plurality of additional pieces of adhesive placed to secure a plurality of additional optical elements to the structure of the optical device, wherein the optical device includes a plurality of other optical elements that couple with the additional optical elements, and wherein tapered ends of the additional optical elements and tapered ends of the other optical elements have been aligned; and
a plurality of additional securing structures formed over the aligned tapered ends of the additional optical elements and the other optical elements, wherein the plurality of additional securing structures are formed by applying photons of light to a photo-active liquid polymer in which the aligned tapered ends of the additional optical elements and the tapered ends of the other optical elements have been immersed.

18. A photonic device, comprising:
a first optical element;
a second optical element;
adhesive placed to secure the first optical element to a structure of an optical device included in the photonic device, wherein tapered ends the first optical element and the second optical element have been aligned; and
an additional securing structure formed over the aligned tapered ends of the first and second optical elements, wherein the additional securing structure is formed by applying photons of light to a photo-active liquid polymer in which the aligned tapered ends of the first and second optical elements have been immersed.

19. The photonic device of claim 18, wherein the photonic device is, or comprises, a quantum repeater.

20. The photonic device of claim 18, wherein the photonic device is, or comprises, a quantum memory.
